(19) United States
(12) Patent Application Publication
(10) Pub. No.: US 2026/0326761 A1
(43) Pub. Date: Oct. 22, 2026

(54) Method for Operating a Driver Assistance System of a Vehicle with Provision of a Following Travel Mode for Following a Road User Ahead, Driver Assistance System and Vehicle

(71) Applicant: Bayerische Motoren Werke Aktiengesellschaft, Muenchen (DE)

(72) Inventor: Alexander GOETZ, Muenchen (DE)

(21) Appl. No.: 19/105,653

(22) PCT Filed: Aug. 18, 2023
(86) PCT No.: PCT/EP2023/072818

§ 371 Date: Feb. 21, 2025

(30) Foreign Application Priority Data
Aug. 23, 2022 (DE) 10 2022 121 280.7

(51) Int. Cl. B60W 30/165; B60W 50/14; B60W 60/00

(52) U.S. Cl. CPC B60W 30/165; B60W 50/14; B60W 60/0025; B60W 2050/146; B60W 2540/215; B60W 2554/4046

(57) ABSTRACT

A method for operating a driver assistance system of a vehicle includes checking whether a road user ahead is recognized in an environment of the vehicle, offering a standard transverse guidance mode with automated transverse guidance of the vehicle, wherein in the standard transverse guidance mode the road user ahead is followed at least intermittently as long as predetermined functional conditions are met, and wherein the functional conditions describe at least one driving behavior of the vehicle and/or of the road user ahead. A following travel mode is additionally offered if the road user ahead is recognized, wherein in the following travel mode the road user ahead is followed independently of the meeting of the functional conditions with automated transverse guidance, and wherein in the following travel mode an output is given which describes that the road user ahead is being followed independently of meeting the functional conditions.

### BACKGROUND AND SUMMARY

The present invention relates to a method for operating a driver assistance system of a vehicle. Furthermore, the present invention relates to a driver assistance system for a vehicle. Lastly, the present invention relates to a vehicle having such a driver assistance system.

In the present case, interest is focused on driver assistance systems that support a driver in transverse guidance of the vehicle. Such driver assistance systems, which are also referred to as steering and lane guidance assistants or active lane keeping assistants, are used to keep the vehicle within a lane or the roadway. Such a driver assistance system uses the data from one or more of the vehicle's environment sensors to recognize the boundaries of a lane or roadway markings. If these lane markings are recognized with sufficient certainty, the lane guidance assistant can be activated and steering interventions can be carried out to keep the vehicle within the lane or roadway. For example, the steering interventions can be carried out in such a way that the vehicle is kept centered within the roadway.

In the known prior art, the lane departure warning systems of various manufacturers have a partial function, for example, in which it is possible to a limited extent to drive behind an object ahead or a road user driving ahead. At least no visible roadway markings are required for this, but numerous other functional conditions are tested. On the one hand, these numerous restrictions ensure the safety of the driver assistance system, as such a following travel mode is terminated if one of the functional conditions is violated. On the other hand, these restrictions lead to greatly reduced availability and frequent frustration on the part of the customer, as the steering assistant often does not reliably follow a given road user ahead.

In this context, EP 1 852 325 A1 describes a method for following control for a motor vehicle. Here, the motor vehicle is longitudinally and transversely controlled on a traffic route with several lanes in such a way that a vehicle ahead is followed by the motor vehicle as a result of the longitudinal and transverse guidance. For example, the trajectory of the vehicle ahead can be followed as precisely as possible. If a lane change of the vehicle ahead is recognized, the following of the vehicle ahead can be interrupted or aborted.

It is the object of the present invention to demonstrate a solution for extending the functionality of a driver assistance system to support transverse guidance of the vehicle.

According to the invention, this object is achieved by a method, by a driver assistance system and by a vehicle having the features according to the independent claims. Advantageous developments of the present invention can be found in the dependent claims.

A method according to the invention is used to operate a driver assistance system of a vehicle. The method comprises checking whether a road user ahead is recognized in an environment of the vehicle. In addition, the method comprises offering a standard transverse guidance mode with automated transverse guidance of the vehicle, wherein in the standard transverse guidance mode the vehicle follows the road user ahead at least temporarily as long as predetermined functional conditions are met. The functional conditions describe at least one driving behavior of the vehicle and/or the road user ahead. In addition, a following travel mode is offered if the road user ahead is recognized, wherein in the following travel mode the road user ahead is followed with automated transverse guidance independently of whether the functional conditions are met, and wherein in the following travel mode an output is issued which describes that the road user ahead is being followed independently of whether the functional conditions are met.

The driver assistance system can have at least one environment sensor by means of which environment data can be provided. This environment data can describe the environment of the vehicle or an environment of the vehicle. The environment sensor can be a camera, for example, by means of which image data can be provided as the environment data. By means of the driver assistance system or a computing device of the driver assistance system, lane boundaries or lane markings can then be recognized in the environment data, which limit the lane on which the vehicle is currently located. It may also be possible that lane boundaries of other lanes or adjacent lanes are recognized.

If these lane boundaries are reliably recognized with a predetermined probability or certainty for a predetermined period of time, the standard transverse guidance mode of the driver assistance system can be activated. This means that the driver assistance system provides a steering torque or performs steering interventions to keep the vehicle within the lane or the roadway.

In addition, it is intended that the environment data is used to check whether there is at least one road user ahead in the vicinity of the vehicle and in particular in front of the vehicle in the direction of forward travel. The road user ahead can be another road user or another vehicle that is located in front of the vehicle in the direction of forward travel. It is not necessary for the road user ahead to be a road user located directly in front of the vehicle.

If such a road user ahead has been recognized, it can also be followed in the standard transverse guidance mode. When following, for example, the relative position of the road user ahead to the vehicle can be continuously determined on the basis of the environment data of the environment sensor and the transverse guidance of the vehicle can be adapted so that the road user ahead is followed with regard to transverse guidance. In particular, it is also intended that the longitudinal guidance of the vehicle is adapted to the road user ahead by means of the driver assistance system. This can be achieved, for example, by means of adaptive cruise control or adaptive distance control.

In the standard transverse guidance mode, it is particularly intended that the vehicle only follows the road user ahead if the predetermined functional conditions are met. These functional conditions or the driving behavior can describe the driving behavior of the vehicle and/or the road user ahead. For example, the functional conditions can describe the speeds of the vehicle or the road user ahead, the transverse acceleration of the vehicle or the road user ahead or the like. The road user ahead can only be followed if these functional conditions are met. In particular, it is intended that the road user ahead can only be followed for a defined period of time in the standard transverse guidance mode. Otherwise, the following travel or automated transverse guidance can be aborted. In this way, the standard transverse guidance mode can be used, for example, to briefly bridge a situation in which the road markings are not recognized or not sufficiently recognized.

According to the present invention, the user or driver of the vehicle is additionally offered the following travel mode if the road user ahead is recognized. In this forced following travel mode, the vehicle can follow the road user ahead with automated transverse guidance and, in particular, also with automated longitudinal guidance, independently of whether the functional conditions are met. It is also envisaged that no time limit is specified for the following travel mode. It is possible to follow the road user ahead if this road user is recognized with a predetermined probability or reliability.

The principle of the present invention is based on a separate setting of the existing driver assistance system or steering assistant, which can maximize the availability of object following. For example, this following travel mode can be set via a menu. Furthermore, it may be possible to offer or provide the driver with this following travel mode in a game-like form, or so-called gamification. It is also envisaged that in the following travel mode, the driver or user will receive an output indicating that the road user ahead is being followed independently of whether the functional conditions are met. An output is also issued to the driver in this context, informing them that they must monitor the driving maneuvers performed by the vehicle. The driver is thus informed that risks may arise in the following travel mode and that the driver must monitor the environment or road traffic.

When the following travel mode is activated, the driver assistance system or the steering assistant currently logs the object in front of the vehicle as the target object, which is then followed. The check of all the conditions or functional conditions explained at the outset can be deactivated so that transverse guidance is maintained in following travel mode independently of these conditions. This provides a “forced object following travel” in the following travel mode. Overall, the function of the driver assistance system for automated transverse guidance of the vehicle can be extended in this way.

Preferably, the functional conditions describe a speed of the vehicle, a speed of the road user ahead, a transverse acceleration of the vehicle, a transverse acceleration of the road user ahead, an orientation of the vehicle, an orientation of the road user ahead and/or a distance between the vehicle and the road user ahead. For example, in the standard transverse guidance mode, the following travel can only be maintained up to a certain speed of the vehicle or the road user ahead. Furthermore, the following travel in the standard transverse guidance mode can only be maintained up to a certain transverse acceleration of the own vehicle or the road user ahead. Alternatively or additionally, it may be provided that the following travel in the standard transverse guidance mode is determined as a function of the alignment, the relative position and/or the distance between the vehicle and the road user ahead. In the following travel mode, it is generally possible that the aforementioned functional conditions are not taken into account or are not used as an abort criterion.

Furthermore, it is advantageous if, in the following travel mode, the vehicle follows the road user ahead even if the road user ahead performs a lane change maneuver and/or if the road user ahead performs a turning maneuver. It is therefore intended that the following travel mode is maintained even if the road user ahead performs a lane change maneuver. This applies in the same way to turning maneuvers in which the vehicle ahead performs a turning maneuver. In this case too, it is possible to follow the road user ahead. The safety of the driver assistance system or the steering assistant remains ensured during the following travel mode, as the driver is always made aware by corresponding outputs or displays that this mode is active and that reliable following of the target object or the road user ahead is taking place.

In particular, it is intended that an output is issued before the road user ahead, who is performing a lane change maneuver or a turning maneuver, is followed. If, for example, the environment data from the environment sensor is used to recognize that the road user ahead is performing a lane change maneuver, an output can be sent to the driver before this lane change maneuver is performed or the road user ahead is followed. This applies in the same way to a turning maneuver by the road user ahead. For example, the driver can be informed visually and/or acoustically that the road user ahead is being followed during the lane change maneuver or the turning maneuver. For example, corresponding arrows or other symbols can be displayed which illustrate the future trajectory of the vehicle when following the lane change maneuver or the turning maneuver. For example, this can be done using augmented reality in a displayed image of the surroundings. In addition, a text can be displayed and/or emitted acoustically, which indicates the future turning maneuver or lane change. In this way, it can be made clear to the driver once again that the road user ahead is also being followed in the following travel mode during a turning maneuver or lane change. It is also possible for the corresponding direction indicators to be activated automatically if the road user ahead is being followed when changing lanes or performing a turning maneuver. In this way, the following traffic can be informed of the intention of their own vehicle.

It is also advantageous if a display is provided that describes the environment of the vehicle, wherein the road user ahead who is being followed is highlighted in the display. As explained above, an output can be provided to the driver in the following travel mode. For example, this output can be provided in the form of the display. In this display, the driver can be shown the area around the vehicle and other road users in this area. For example, symbols representing the other road users or road users ahead can be displayed. When the following travel mode is activated, the road user ahead who is currently being followed can be highlighted. This is particularly suitable if there are several road users in front of the vehicle. In this way, the driver can be informed which of these road users is currently being followed in the following travel mode. This road user ahead or its representation can be visually highlighted by a coloring, a marking, a border or the like.

In a further embodiment, if a plurality of road users ahead are recognized, these are displayed to the driver and offered for selection for following in the following travel mode. As explained above, the recognized road users ahead can be displayed. For the activation or after the activation of the following travel mode, the driver can then select one of the road users ahead, which is then actually followed in the following travel mode. It may also be possible for the road user or driver to change the road user ahead to be followed during the following travel mode by making a corresponding operating input. In other words, a different road user can be selected in the following travel mode, who is then followed. This enables simple and convenient operation of this following travel mode for the driver or user.

Furthermore, it is advantageous if an emergency braking function and/or a side collision warning is activated or remains activated in the following travel mode. The safety of the driver assistance system or the steering assistant remains ensured during the following travel mode by the fact that, for example, an emergency braking function and/or a driver assistance function for avoiding a side collision is activated or remains activated. In this way, a collision between the vehicle and another road user can be prevented during the following travel mode.

Furthermore, the driver preferably has the option of deactivating the following travel mode at any time by means of a predetermined operating action. This control action can, for example, be an intervention in the steering wheel. If, for example, a predetermined steering wheel angle and/or a predetermined steering wheel torque is exceeded, the following travel mode can be deactivated. The following travel mode can also be deactivated if the driver presses the brake pedal. Furthermore, it may be provided that the following drive mode is terminated when the driver actuates a corresponding control element to deactivate the following drive mode.

It is also advantageous if the following travel mode is not interrupted when the turn signals are activated by the driver. In other words, the following travel mode cannot be interrupted when the driver activates the blinker lever. This applies if the driver activates the blinker lever when the road user ahead performs a lane change maneuver and/or a turning maneuver. In this case, the actuation of the blinker lever or the activation of the turn signal by the driver can be regarded as confirmation that the road user ahead is being followed.

A driver assistance system according to the invention for a vehicle is set up to check whether a road user ahead is recognized in a vicinity of the vehicle. In addition, the driver assistance system is set up to offer a standard transverse guidance mode with automated transverse guidance of the vehicle, wherein the vehicle in the standard transverse guidance mode at least temporarily follows the road user ahead as long as predetermined functional conditions are met. The functional conditions describe at least one driving behavior of the vehicle and/or the road user ahead. The driver assistance system is also set up to additionally offer a following travel mode if the road user ahead is recognized, wherein the vehicle follows the road user ahead in the following travel mode with automated transverse guidance independently of whether the functional conditions are met. Furthermore, the driver assistance system is set up to output an output in the following travel mode, which describes that the vehicle is following the road user ahead independently of whether the functional conditions are met.

The driver assistance system can have at least one environment sensor by means of which environment data can be provided. At least one road user ahead can be recognized in the environment data by means of a computing device of the driver assistance system. In addition, the driver assistance system can have an output device to provide an output to the driver. In principle, the output can be visual, acoustic and/or haptic. The output device can preferably comprise at least one readout, a display, a head-up display or the like. Furthermore, the driver assistance system can take over the transverse guidance and preferably also the longitudinal guidance of the vehicle in order to follow the road user ahead.

A vehicle according to the invention comprises a driver assistance system according to the invention. The vehicle may be designed as a passenger car.

The preferred embodiments presented with reference to the method according to the invention and their advantages apply accordingly to the driver assistance system according to the invention and to the vehicle according to the invention.

Further features of the invention can be found in the claims, the figures and the description of the figures. The features and combinations of features mentioned above in the description and the features and combinations of features mentioned below in the description of the figures and/or shown alone in the figures can be used not only in the combination indicated in each case, but also in other combinations or on their own, without departing from the scope of the invention.

The invention will now be explained in greater detail with reference to preferred exemplary embodiments and with reference to the accompanying drawings, in which:

### BRIEF DESCRIPTION OF THE DRAWINGS

FIG. 1 shows a schematic representation of a vehicle which has a driver assistance system; and

FIG. 2 shows the vehicle shown in FIG. 1 in an exemplary traffic situation in which it is following a road user ahead.

### DETAILED DESCRIPTION OF THE DRAWINGS

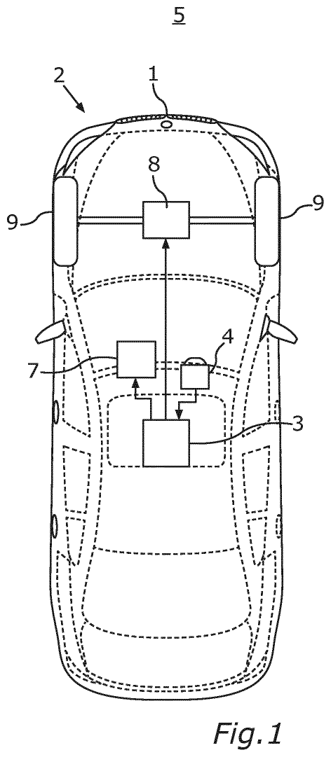

FIG. 1 shows a vehicle 1, which is designed as a passenger car in the present case, in a plan view. The vehicle 1 comprises a driver assistance system 2, by means of which a driver of the vehicle 1 can be assisted in the transverse guidance of the vehicle 1. The driver assistance system 2 comprises a computing device 3, which can, for example, be formed by at least one electronic control unit of the vehicle 1.

In addition, the driver assistance system 2 comprises at least one environment sensor 4. In the example shown, the driver assistance system 2 comprises an environment sensor 4, which is designed as a camera in the present case. The environment sensor 4 can be used to provide environment data or image data that describe an environment 5 of the vehicle 1.

The computing device 3 is also set up to control a steering system 8 of the vehicle 1, which is only shown schematically here. By controlling the steering system 8, a steering torque or steering engagement can be generated. By controlling the steering system, the steerable wheels 9 of the vehicle 1 can be steered and thus the transverse guidance of the vehicle 1 can be influenced. In addition, the driver assistance system 2 can take over longitudinal guidance of the vehicle 1.

In addition, the driver assistance system 2 comprises an output device 7, by means of which an output can be provided to a driver or user of the vehicle 1. The output device 7 can comprise at least one display device or a display with which an optical display can be provided as an output. In addition, an acoustic and/or haptic output can be provided by means of the output device 7.

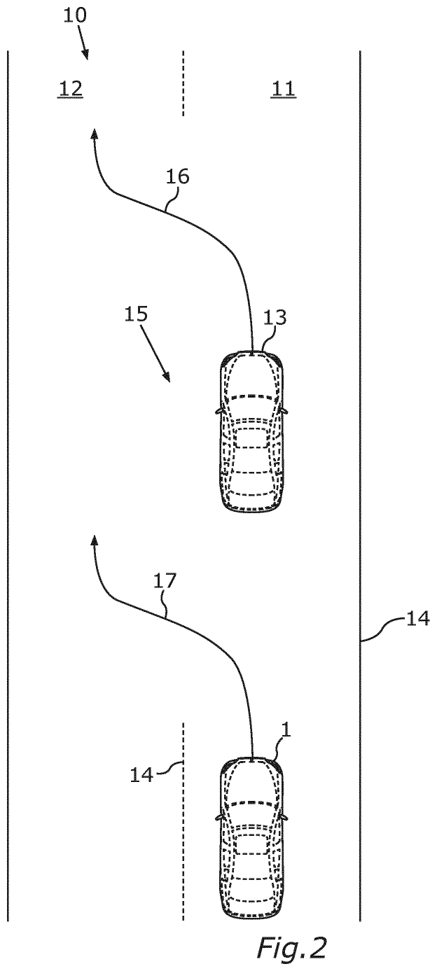

FIG. 2 shows the vehicle 1 according to FIG. 1 in a schematically depicted traffic situation. The vehicle 1 is located on a road 10, which has a first lane 11 and a second lane 12. There is a road user 13 ahead of the vehicle 1 in the direction of forward travel. The road user ahead 13 is another passenger car.

The environment data provided by the environment sensor 4 or the camera can be used to recognize lane boundaries 14, which delimit the first lane 11. In the present case, the lane boundaries 14 are road markings. If these lane boundaries 14 are recognized, a standard transverse guidance mode of the driver assistance system 2 can be activated. In this standard transverse guidance mode, the steering system 8 can be controlled by the control unit 3 in such a way that the vehicle 1 is kept centered within the first lane 11.

In an area 15 of the road 10, the lane markings between the first lane 11 and the second lane 12 are not present or cannot be recognized based on the environment data. In this case, the standard transverse guidance mode can be used to briefly follow the road user ahead 13 and thus maintain the automated transverse guidance for stopping the vehicle 1 within the lane 11. In the standard transverse guidance mode, the vehicle can then follow the road user ahead 13 if predetermined functional conditions are met. These functional conditions can, for example, describe the speed of the vehicle 1, the speed of the road user ahead 13, the transverse acceleration of the vehicle 1, the transverse acceleration of the road user ahead 13 and/or the relative position or alignment between the vehicle 1 and the other road user 13.

It is also provided that the driver is offered a following travel mode in the event that the road user ahead 13 is reliably recognized. In this following travel mode, the automated transverse guidance of the vehicle 1 can be carried out by the driver assistance system 2 in such a way that the vehicle follows the road user ahead 13 independently of whether the functional conditions are met. In this following travel mode, the output device 7 can also output a message to the driver informing them that the vehicle is following the road user ahead 13 and that the functional conditions are not taken into account during the following travel mode.

In the example shown in FIG. 2, it is assumed that the driver of vehicle 1 is on their daily journey from home to the office. After turning onto the road 10, the driver can activate the driver assistance system or the standard transverse guidance mode of the driver assistance system 2. The driver assistance system 2 can then be used to follow the object in a limited way without the driver having to provide significant assistance.

However, if the driver knows their route or the conditions of the road 10, they know, for example, that there are numerous sections of the road 10 or the route in which the steering assistant or the driver assistance system 2 cannot automatically take control of the vehicle. This may be the case, for example, in areas 15 in which the road markings or lane markings 14 are not present.

In this example, the driver can activate the following travel mode and follow the road user ahead 13. By means of the output device 7, a warning can then be issued to the driver that the driver must monitor the route of their vehicle 1 and that their vehicle 1 will consistently follow the road user ahead 13. The driver can then rely on the driver assistance system 2 of his vehicle 1 to follow the road user ahead 13, who, for example, drives most of their route in the same way. As soon as the driver has to take a different route from the road user ahead 13, the driver can end the following travel mode by pressing a button or by operating the steering wheel.

The following travel mode can also be maintained if the road user ahead 13 performs a lane change maneuver. This is shown here by the trajectory 16, which is performed by the road user ahead. In this case, a lane change maneuver is also performed by the vehicle 1, and the vehicle 1 is maneuvered along the trajectory 17. The following travel mode can also be maintained if the road user ahead 13 performs a turning maneuver. In the following travel mode, an emergency brake assistant and/or an assistant for avoiding side collisions can remain activated to ensure safety.

1.-10. (canceled)

11. A method for operating a driver assistance system of a vehicle, the method comprising:
checking whether a road user ahead of the vehicle is recognized in an environment of the vehicle;
offering a standard transverse guidance mode with automated transverse guidance of the vehicle;
wherein, in the standard transverse guidance mode, the road user is followed at least temporarily as long as predetermined functional conditions are met, and
wherein the functional conditions describe at least one driving behavior of the vehicle and/or of the road user;
wherein a following travel mode is also offered if the road user is recognized;
wherein, in the following travel mode, the road user is followed with automated transverse guidance independently of whether the functional conditions are met; and
wherein, in the following travel mode, an output is issued which describes that the road user is being followed independently of whether the functional conditions are met.

12. The method according to claim 11, wherein the functional conditions describe a speed of the vehicle, a speed of the road user, a transverse acceleration of the vehicle, a transverse acceleration of the road user, an orientation of the vehicle, an orientation of the road user and/or a relative position between the vehicle and the road user.

13. The method according to claim 11, wherein, in the following travel mode, the road user is also followed when the road user performs a lane change maneuver and/or when the road user performs a turning maneuver.

14. The method according to claim 12, wherein, in the following travel mode, the road user is also followed when the road user performs a lane change maneuver and/or when the road user performs a turning maneuver.

15. The method according to claim 13, wherein an output is issued before the road user, who is performing a lane change maneuver or a turning maneuver, is followed.

16. The method according to claim 14, wherein an output is issued before the road user, who is performing a lane change maneuver or a turning maneuver, is followed.

17. The method according to claim 11, wherein a display is provided which describes the environment of the vehicle, wherein the road user is highlighted in the display.

18. The method according to claim 11, wherein, in a case in which a plurality of road users ahead of the vehicle is recognized, the plurality of road users are displayed to the driver and are offered for selection for following in the following travel mode.

19. The method according to claim 12, wherein, in a case in which a plurality of road users ahead of the vehicle is recognized, the plurality of road users are displayed to the driver and are offered for selection for following in the following travel mode.

20. The method according to claim 11, wherein an emergency braking function and/or side collision warning is activated or remains activated in the following travel mode.

21. The method according to claim 12, wherein an emergency braking function and/or side collision warning is activated or remains activated in the following travel mode.

22. The method according to claim 11, wherein the following travel mode is not aborted when the turn signals are activated by the driver.

23. The method according to claim 12, wherein the following travel mode is not aborted when the turn signals are activated by the driver.

24. A driver assistance system for a vehicle, wherein the driver assistance system is configured to:
check whether a road user driving ahead of the vehicle is recognized in an environment of the vehicle, and
offer a standard transverse guidance mode with automated transverse guidance of the vehicle,
wherein the vehicle in the standard transverse guidance mode at least temporarily follows the road user while predetermined functional conditions are met, and
wherein the functional conditions describe at least one driving behavior of the vehicle and/or of the road user,
wherein the driver assistance system is also configured to additionally offer a following travel mode when the road user is recognized,
wherein the vehicle follows the road user in the following travel mode with automated transverse guidance, independently of whether the functional conditions are met, and
in the following travel mode, an output is issued which describes that the road user is being followed independently of whether the functional conditions are met.

25. A passenger car comprising a driver assistance system according to claim 24.
